(19) United States
(12) Patent Application Publication
(10) Pub. No.: US 2010/0182779 A1
(43) Pub. Date: Jul. 22, 2010

(54) DISPLAY PANEL WITH USERS' OWN DESIGN PATTERN

(76) Inventor: Chih-Chung CHIANG, Sindian City (TW)

Correspondence Address: SINORICA, LLC, 2275 Research Blvd., Suite 500, ROCKVILLE, MD, 20850, US

(21) Appl. No.: 12/358,232

(22) Filed: Jan. 22, 2009

(51) Int. Cl. F21L 4/00; F21K 7/00

(52) U.S. Cl. 362/190; 362/227

(57) ABSTRACT

A display panel that users can design patterns as they need is revealed. The display panel includes a circuit substrate and a plurality of light emitting members. The circuit substrate is disposed with a plurality of fixing holes for being inserted by the light emitting members corresponding to a pattern. The light emitting members are fixed on the fixing holes corresponding to the pattern. Thus there is no unnecessary light emitting members and the cost is reduced. Moreover, the pattern on the display can be changed whenever as user's wish. Thus the display panel is more usable and flexible.

### BACKGROUND OF THE INVENTION

1. Field of Invention

The present invention relates to a display panel, especially to a display panel that users can design patterns they require to be displayed thereon.

2. Description of Related Art

Generally, there are a plurality of display panels, signs, and billboards with patterns such as words or figures shown in our surroundings. The way of manufacturing the devices includes printing, attaching, or carving words/figures thereon. If necessary, a spot light is added or the panel is made into a light box so as to enhance visual effects of the billboards or displays and draw people's attention.

Refer to FIG. 1, a common panel available now is revealed. The panel is a kind of light box 1′ printed with advertising patterns 11′ such as words, slogans, figures etc that owners request. Through various lighting modes of the light source in the light box 1′, people know what the advertisement is really asking for. Thus the purpose of users to announce or deliver messages is achieved.

However, the applications of such kind of device are limited. Once the advertising patterns 11′ (words, slogans or figures) printed on the surface of the light box 1′ are made, they are unable to be modified or changed. If the users want to change the message temporarily such as removal notice, or the next user of the light box 1′ wants to set new advertising patterns, there is no other way to put them. Thus the practice value of the device is not enough. Moreover, once the user is changed, the advertising they require is also changed. This leads to great waste of labor and resources.

Furthermore, for convenience of changing patterns, now the display panel is disposed with plenty of light emitting elements such as bulbs. Yet such way uses too many unnecessary light emitting elements and increases the cost of the display panel.

Thus there is a need to provide a new display panel that users can design their own patterns to overcome above shortcomings. The user can assemble required light emitting elements on the display panel according to the pattern they wish. Thus there is no unnecessary light emitting elements and the cost is reduced. Moreover, the patterns can be changed at any time according to user's mood or preference.

### SUMMARY OF THE INVENTION

Therefore it is a primary object of the present invention to provide a display panel that users can design patterns they need. A plurality of light emitting members corresponding to a pattern is disposed on a display panel. Thus there is no unneeded light emitting members installed on the display panel and the cost is reduced

It is another object of the present invention to provide a display panel that users can design patterns they need, in which patterns on the display panel can be changed whenever users want. Thus the usability of the display panel is better and the design is more flexible.

The display panel that users can design patterns they need according to the present invention consists of a circuit substrate and a plurality of light emitting members. A plurality of fixing holes is arranged on the circuit substrate for being assembled with the light emitting members that correspond to a pattern. The light emitting members are fixed on the circuit substrate by the fixing holes.

Furthermore, the display device includes a first electrode layer, an insulation layer and a second electrode layer. The first electrode layer is disposed with a plurality of fixing holes that connect with and fix an electrode of each of the light emitting members. The insulation layer is arranged over the first electrode layer. A plurality of fixing holes corresponding to those fixing holes on the first electrode layer is disposed on the second electrode layer and so is the insulation layer. The other electrode of the light emitting members connects with these fixing holes.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing of a prior art of a display panel;

FIG. 2 is an explosive view of an embodiment according to the present invention;

FIG. 3 is a perspective view of an embodiment according to the present invention;

FIG. 4 is an explosive view of another embodiment according to the present invention;

FIG. 5 is a cross sectional view of another embodiment according to the present invention;

FIG. 6A is a perspective view of a light emitting member according to the present invention; and

FIG. 6B is a schematic drawing showing another light emitting member according to the present invention.

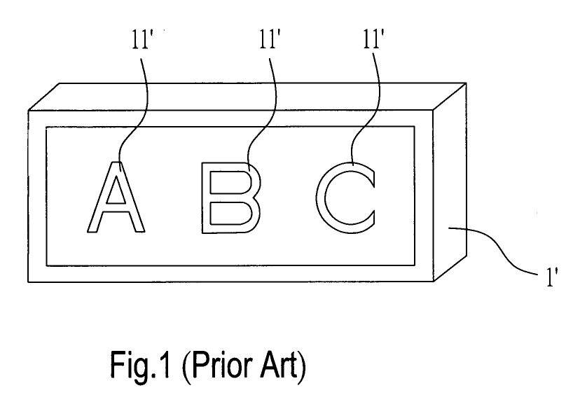

### DETAILED DESCRIPTION OF THE PREFERRED EMBODIMENT

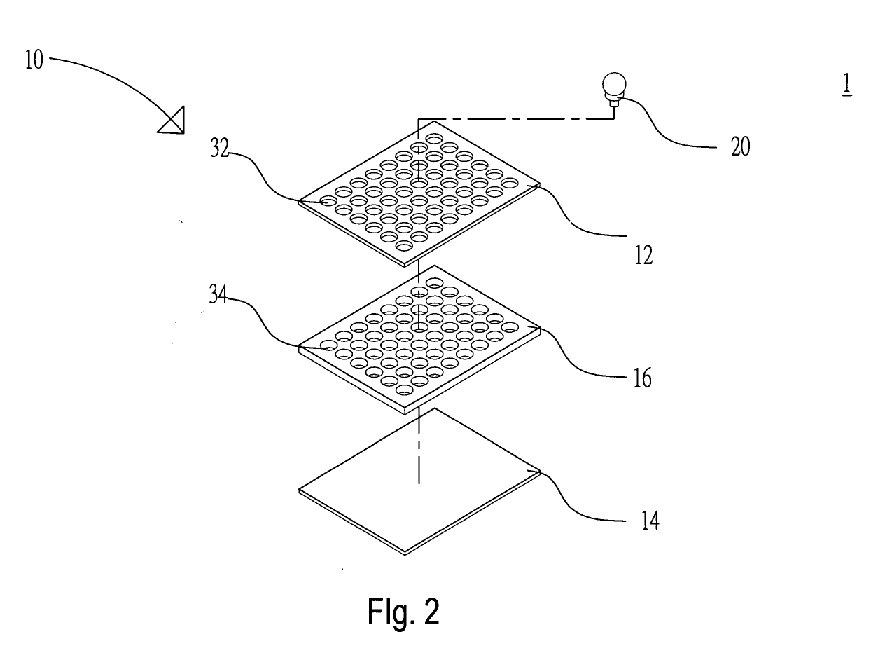

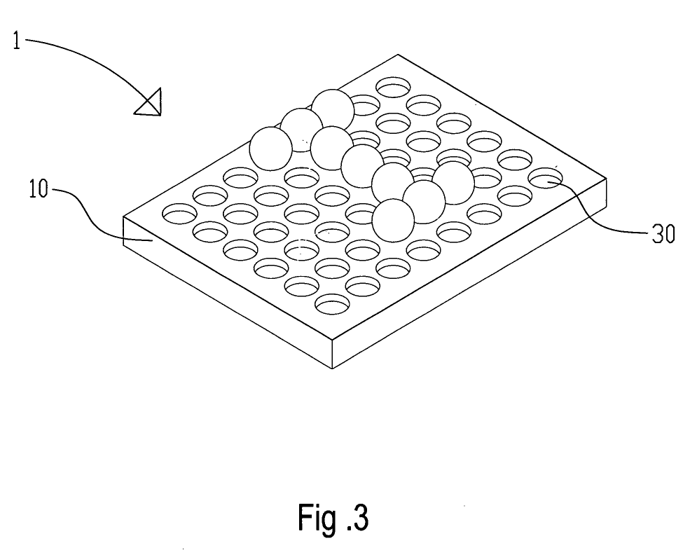

Refer to FIG. 2 & FIG. 3, an explosive view and a perspective view of an embodiment according to the present invention are revealed. A display panel that users can design their own patterns as they wish 1 includes a circuit substrate 10 and a plurality of light emitting members 20. The circuit substrate 10 consists of a plurality of fixing holes 30. According to a preset pattern, the light emitting members 20 are mounted into the fixing holes 30 corresponding to the pattern. That means users can assemble the light emitting members 20 with the fixing holes 30 of the display panel 1 according to the patterns they need so as to form the patterns they require. As shown in FIG. 3, the light emitting members 20 of the display panel 1 are arranged on the circuit substrate 10 to form a “I” symbol. This is only an embodiment of the present invention and the patterns are not limited to this symbol. Thus, there is no unneeded light emitting members 20 installed on the display panel 1 of the present invention and the cost is reduced. Moreover, when users want to change patterns or words on the display panel 1 due to the mood or some other factors, they can disassemble the light emitting members 20 with the circuit substrate 10 of the display panel 1. Then rearrange the light emitting members 20 on the circuit substrate 10 of the display panel 1 to form another pattern or word they require. Thus by means of the light emitting members 20 easily assembled or disassembled with the circuit substrate 10, patterns or words on the circuit substrate 10 of the display panel 1 are easier to be modified or changed. Therefore, the usability of the display panel 1 is further enhanced.

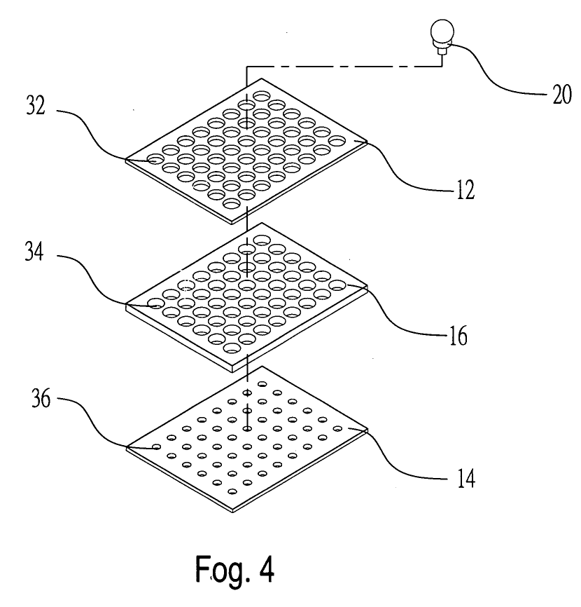

Refer to FIG. 4, an explosive view of another embodiment is disclosed. As shown in pattern, the difference between this embodiment and the one in FIG. 2 is in that a plurality of fixing holes 36 are further disposed on a second electrode layer 14. When the light emitting members 20 are arranged on the circuit substrate 10, the second electrode of the light emitting members 20 are fixed by those fixing holes 36 so as to avoid poor contact between a second electrode 24 and the second electrode layer 14 caused by shaking or vibration of the display panel 1.

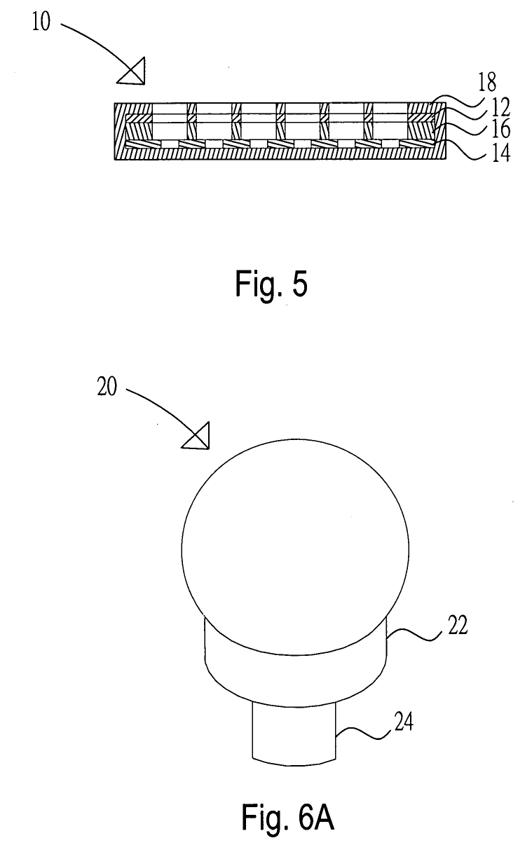

Refer to FIG. 5, a cross sectional view of an embodiment according to the present invention is disclosed. The circuit substrate 10 of the display panel 1 according to the present invention includes a first electrode layer 12, a second electrode layer 14, an insulation layer 16 and a shell 18. The first electrode layer 12 consists of a plurality of fixing holes 32 that connect with and fix a first electrode 22 of each of the light emitting members 20. The second electrode layer 14 is disposed under the first electrode layer 12 and a second electrode 24 of each of the light emitting members 20 connects to the second electrode layer 14. The insulation layer 16 is arranged between the first electrode layer 12 and the second electrode layer 14. A plurality of fixing holes 34 corresponding to the fixing holes 32 of the first electrode layer 12 are disposed on the insulation layer 16 so that the second electrodes 24 of the light emitting members 20 inserts through the fixing holes 32 of the first electrode layer 12, the fixing holes 34 of the insulation layer 16 and connect with the second electrode layer 14. Thus the insulation layer 16 separates the first electrode layer 12 and the second electrode layer 14 to avoid short circuit caused by the first electrode layer 12 contacting with the second electrode layer 14.

Moreover, the circuit substrate 10 of the display panel further includes the shell 18 that covers the first electrode layer 12, the second electrode layer 14, and the insulation layer 16 inside for preventing the first electrode layer 12 as well as the second electrode layer 14 from contacting other objects and causing short circuit. Furthermore, the display panel 1 is coupled to a power source unit 40 for providing electricity to the light emitting members 20 connected with the circuit substrate 10. The power source unit 40 is a dry battery or a rechargeable battery that is able to be disposed inside the circuit board 10 for convenience of carry by the display panel 1. The power source unit 40 can also be a solar battery that is arranged on an outer side of the display panel to absorb solar energy and convert the solar energy into electricity, being supplied to the circuit substrate 10 for displaying patterns.

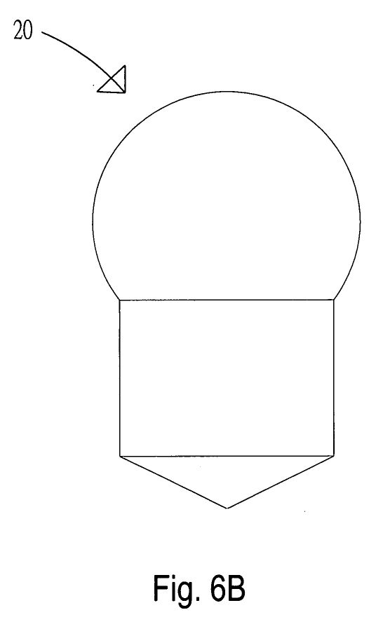

Refer to FIG. 6A, a perspective view of a light emitting member is disclosed. As shown in pattern, the light emitting member 20 is a light emitting diode (LED) that includes a first electrode 22 and a second electrode 24. The first electrode 22 and the second electrode 24 of the LED are arranged in a circular form while the diameter of the first electrode 22 is larger than that of the second electrode 24. Thus the LED is easy to be assembled or disassembled with the circuit substrate 10.

Refer to FIG. 6B, another light emitting member is revealed. As shown in pattern, the light emitting member 20 is a bulb that is easy to be set on the circuit substrate 10. Moreover, the bulb can be covered with a color film. The color of the color film depends on users' preference so that the usability of the display panel 1 is improved. The light emitting members 20 shown in FIG. 6A & FIG. 6B are only some embodiments, not intended to limit the scope of the device.

In summary, the display panel with users' own design patterns of the present invention includes a circuit substrate with a plurality of fixing holes and a plurality of light emitting members. According to a pattern the user requires, the light emitting members are assembled with and fixed by the fixing holes. Thus there is no unneeded light emitting members installed on the display panel and the cost is reduced. Moreover, the patterns on the display panel can be changed whenever the user wants so that the usability of the device is enhanced.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A display panel that users can design patterns they need comprising:
a circuit substrate disposed with a plurality of fixing holes, and
a plurality of light emitting members that are fixed on the fixing holes according to a pattern.

2. The device as claimed is claim 1, wherein the circuit substrate comprising:
a first electrode layer having a plurality of fixing holes that connect with an electrode of each light emitting member,
an insulation layer disposed under the first electrode layer, and
a second electrode layer arranged with a plurality of fixing holes corresponding to the fixing holes of the first electrode layer, and the second electrode layer being disposed under the insulation layer.

3. The device as claimed is claim 2, wherein diameter of the fixing holes of the first electrode layer is different from diameter of the fixing holes of the second electrode layer.

4. The device as claimed is claim 2, wherein the circuit substrate further comprising:
a shell for accommodating the first electrode layer, the insulation layer and the second electrode layer.

5. The device as claimed is claim 1, wherein the circuit substrate further comprising:
a first electrode layer having a plurality of fixing holes that connect with an electrode of each light emitting member, an insulation layer disposed under the first electrode layer, and
a second electrode layer disposed under the insulation layer and the other electrode of each light emitting member connects with the second electrode.

6. The device as claimed is claim 1, wherein the light emitting member is a light emitting diode (LED) or a bulb.

7. The device as claimed is claim 6, wherein the bulb further comprising a color film that covers on a surface thereof.

8. The device as claimed is claim 1, wherein the display panel further comprising:
a power source unit disposed in the circuit substrate for providing electricity to the light emitting members connected with the circuit substrate

9. The device as claimed is claim 8, wherein the power source unit having at least one dry battery.

10. The device as claimed is claim 8, wherein the power source unit including at least one rechargeable battery.

11. The device as claimed is claim 8, wherein the power source unit comprising at least one solar battery.
